(19) United States
(12) Patent Application Publication
(10) Pub. No.: US 2011/0265492 A1
(43) Pub. Date: Nov. 3, 2011

(54) FREEZER WITH CRYOGEN INJECTION CONTROL SYSTEM

(76) Inventors: Michael D. Newman, Hillsborough, NJ (US); Stephen A. McCormick, Warrington, PA (US)

(21) Appl. No.: 12/769,110

(22) Filed: Apr. 28, 2010

(51) Int. Cl. A23L 3/36; F25D 31/00

(52) U.S. Cl. 62/1; 62/347

(57) ABSTRACT

A freezer for reducing the temperature of product is provided which includes a controller in communication with and for receiving signals from the cryogen delivery assembly, the cryogen flow assembly, the conveyor, the product measurement assembly and the first heat sensor, the controller responsive to the signals for controlling the cryogen flow assembly to provide an amount of the cryogen to the cryogen delivery assembly for application to the product.

### BACKGROUND

The present embodiments relate to cryogen freezers for processing for example food products.

Known freezers used with, for example, food products determine an amount of cryogen injection for the freezer based upon a temperature of an internal freezing space of the freezer where chilling and/or freezing of the food product is to occur. Unfortunately, such known methods are problematic in that the freezing rate of the product is not directly related to the temperature of the freezer. This is especially so when production rates of the product to be introduced to the freezer may be constantly changing. By not monitoring actual product mass flow rates and thermal conditions of and for same, the cryogen provided to the freezer is typically in an amount in excess of that which is needed and accordingly, product is frozen beyond that which is necessary resulting in excessive use of the cryogen resource to freeze the product (wasteful use of cryogen). Alternate situations may find the product not frozen sufficiently, i.e. under frozen and therefore of poor frozen quality.

### BRIEF DESCRIPTION OF THE DRAWINGS

For a more complete understanding of the present embodiments, reference may be had to the following drawing figures taken in conjunction with the description of the embodiments, of which:

FIG. 1 shows an embodiment of a freezer with a cryogen injection control system; and

FIG. 2 shows another embodiment of a freezer with a cryogen injection control system.

### DETAILED DESCRIPTION

In the present embodiments, a flow rate and an amount of a product mass is known, as is a thermal state of the product mass so that an accurate product heat load measurement can be calculated for a flow rate of cryogen to be automatically adjusted for contacting the product. Cryogen used can be carbon dioxide (CO₂) or nitrogen (N₂).

For the present embodiments, an amount of cryogen injected into a food freezer for the products, such as food products, is related to a production rate and the temperature of the food products being processed, i.e. chilled or frozen. In one embodiment, a weight scale and an infrared (IR) temperature sensor are disposed to monitor incoming product rates and related temperatures of the incoming product. A heat load calculation is then performed by a controller for the system, which calculation can be performed in a computer, which will calculate the required cryogen injection flow rate into the freezer responsive to the amount and temperature of the incoming product to the freezer.

Cryogen is provided, such as by injection into the freezer through nozzles, and a flow rate of the injected cryogen can accordingly be metered as a result of injection pressure of the cryogen being monitored. A pressure transducer is disposed upstream of the cryogen injection nozzles, while a modulating control valve is installed upstream of the pressure transducer. A cryogen flow rate required for the particular product and its characteristics can be converted by the controller to generate a signal to the nozzle(s) such that a required pressure of the cryogen is provided for flow through the nozzle. The modulating control valve can then be adjusted, and the pressure transducer reads the required pressure. A flow rate of liquid cryogen through a nozzle can be calculated when the pressure upstream of the nozzle is known. Accordingly, since the required flow rate is known and the characteristics (nozzle orifice size and discharge coefficient) of the nozzles being used are known, a calculation is made (in the control logic) for the required pressure to achieve such flow and modulate the control valve accordingly to achieve the desired pressure at the nozzles.

In another embodiment, an imaging system at an inlet to the freezer is used to monitor the product being feed, continuously or otherwise, into the freezer. A known density of the particular product can then be loaded into the computer to calculate a production rate for the particular product being frozen. An inline cryogenic flow meter may be used with the modulating control valve with respect to the amount of cryogen, such as liquid nitrogen (N₂) or carbon dioxide (CO₂), being introduced into the freezer. Temperature probes or sensors may also be disposed at an outlet or discharge end of the freezer to monitor discharge product temperature. Such temperatures are communicated to the control system for the freezer to adjust as necessary cryogen injection into the freezer system. In this manner, a proper amount of cryogen is used to chill or freeze the product as necessary. The imaging system can also be used to measure product having extremely low temperatures, wherein the IR probes would be ineffective and inaccurate in reading such lower temperatures.

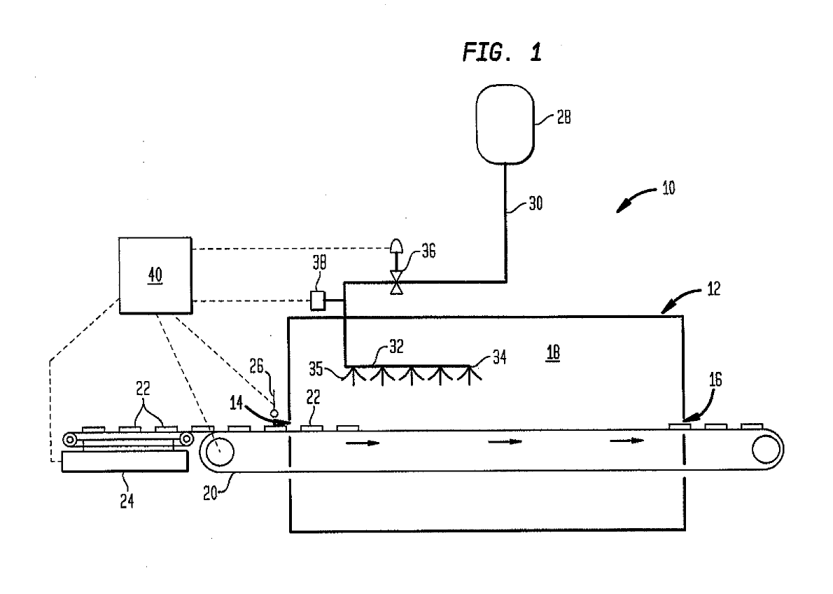

Referring to FIG. 1, a freezer of the present embodiment is shown generally at 10 and includes a housing 12 having at one side thereof an inlet 14 and at another side thereof an outlet 16 or discharge end. An interior space 18 or chamber for chilling and/or freezing within the housing 12 is accessed by the inlet 14, and the outlet 16. A conveyor belt 20 extends through the inlet 14 into the space 18 and through the outlet 16 for transporting products 22, such as food products, through the freezer 10.

A product measurement unit or assembly such as a weight scale 24 is disposed proximate the conveyor belt 20 near the inlet 14. The product 22, in any amount deemed necessary for processing, is loaded on to the scale 24 where it is weighed and subsequently transferred to the conveyor belt 20 for further processing.

An infrared (IR) probe 26 or sensor is disposed proximate the inlet 14 to the chamber 18 in such a manner that the probe 26 is sensitive to and can measure a heat signature of the product 22. The product 22 may be introduced on to the conveyor belt 20 for batch or continuous processing.

A remote source 28 of cryogen, for example liquid nitrogen or carbon dioxide, is provided to the chamber 18 of the housing 10 through a line 30 or conduit. The line 30 terminates in a manifold 32 to which at least one or alternatively a plurality of injection nozzles 34 are mounted for providing a cryogen spray 35 to contact the product 22. The line 30, the manifold 32, the at least one or a plurality of the nozzles 34, and the remote source 28 of cryogen may each form a part of a cryogen delivery assembly.

Interposed in the line 30 between the remote source 28 of cryogen (most likely external to the housing 12) and the manifold 32 is mounted a modulating control valve 36 and a pressure transducer 38. In effect, the pressure transducer 38 is mounted in the line 30 upstream of the manifold 32 and nozzles 34, while the modulating control valve 36 is mounted to the line 30 upstream of the pressure transducer 38. The modulating control valve 36 can be adjusted to control the amount of cryogen being introduced from the remote cryogen source 28 through the line 30 to the manifold 32. The pressure transducer 38 monitors pressure through the line 30 as a result of the position of the control valve 36. Because the nozzles 34 are “fixed”, i.e. not being adjustable nozzles and therefore of a less expensive type, a flow rate of the cryogen to the nozzles 34 can be monitored and regulated with the modulating control valve 36 and pressure transducer 38.

A controller 40 is disposed for receiving signals generated from the scale 24, IR probe 26, modulating control valve 36 and pressure transducer 38. In addition, a speed of the conveyor belt 20 can also be adjusted and such speed communicated to the controller 40 as well.

Therefore, introduction of the product 22 onto the scale 24 coupled with the temperature of the product 22 sensed by the IR probe 26 will determine initially the amount of cryogen to be introduced into the space 18 by the nozzles 34 to contact the product 22 for sufficient chilling or freezing of the product. Accordingly, regardless of whether the product 22 is to be introduced to the freezer continuously or in batches, signals generated from the scale 24, IR probe 26 and the pressure transducer 38 to the controller 40 are provided for adjusting the modulating control valve 36 to provide the requested amount of cryogen to be injected into the space 18 by the nozzles 34 on to the product 22.

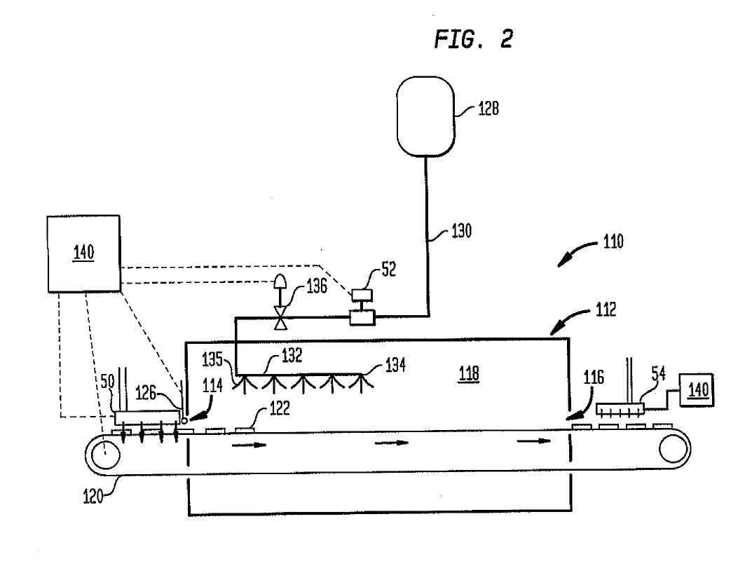

FIG. 2 shows another embodiment of the cryogen freezer. Elements in FIG. 2 which are the same as elements discussed with respect to FIG. 1 are provided with similar reference numbers increased by “100”.

Referring to FIG. 2, another embodiment of a freezer is shown generally at 110 and includes a housing 112 having at one side thereof an inlet 114 and at another side thereof an outlet 116 or discharge end. An interior space 118 or chamber for chilling and/or freezing within the housing 112 is accessed by the inlet 114, and the outlet 116. A conveyor belt 120 extends through the inlet 114 into the space 118 and through the outlet 116 for transporting products 122, such as food products through the freezer 110.

Another product measurement unit or assembly such as an imaging system 50 is disposed proximate the conveyor belt 120 near the inlet 114. The product 122, in any amount deemed necessary for processing, is loaded on to the conveyor belt 120 where it is transferred by the belt proximate the imaging system 50, to be subsequently transferred to the space 118 for further processing. In FIG. 2, the product 122 is transferred for example beneath the imaging system 50. The imaging system 50 observes a continuous three-dimensional footprint of the product 122 passing in proximity to it, and continuously monitors the surface area covered of the belt and height of product passing in proximity to it. The system 50 processes this data, i.e. calculates a continuous volume, with a known product density and discharges a mass flow rate of the product 122.

An infrared (IR) probe 126 or sensor is disposed proximate the inlet 114 to the chamber 118 in such a manner that the probe 126 is sensitive to and can measure a heat signature of the product 122. The product 122 may be introduced on to the conveyor belt 120 for batch or continuous processing.

A remote source 128 of cryogen (most likely external to the housing 112), for example liquid nitrogen (N₂) or carbon dioxide (CO₂), is provided to the chamber 118 of the housing 110 through a line 130 or conduit. The line 130 terminates in a manifold 132 within the chamber 118, to which at least one or alternatively a plurality of injection nozzles 134 are connected for providing a cryogen spray 135 to contact the product 122. The line 130, the manifold 132, the at least one or a plurality of the nozzles 134, and the remote source 128 of cryogen may each form a part of a cryogen delivery assembly.

Interposed in the line 130 between the remote source 128 of cryogen and the manifold 132 is mounted a modulating control valve 136 and a flow meter 52. In effect, the flow meter 52 is mounted in the line 130 upstream of the manifold 132 and injection nozzles 134 between the modulating control valve 136 and the source 128, while the modulating control valve 136 is mounted to the line 130 upstream of the manifold 132. The modulating control valve 136 can be adjusted to control the amount of cryogen being introduced from the remote cryogen source 128 through the line 130 to the manifold 132. The flow meter 52 monitors flow through the line 130 as a result of the disposition of the control valve 136. Because the nozzles 134 are “fixed”, i.e. not being adjustable nozzles and therefore of a less expensive type, a flow rate of the cryogen to the nozzles 134 can be monitored and regulated with the modulating control valve 136 and the flow meter 52. The flow meter 52 is a more precise method of mass flow measurement as it measure true mass flow. In contrast, the pressure transducer 38 measures one variable of the mass flow equation which could be effected by the presence of two phase flow. The flow meter 52 is however more expensive, but both elements may be used.

A controller 140 is disposed for receiving signals generated from the imaging system 50, IR probe 126, modulating control valve 136 and flow meter 52. In addition, a speed of the conveyor belt 120 can also be adjusted and such speed communicated to the controller 140 as well.

A discharge or outlet temperature sensor 54 is disposed at the outlet 116 to sense temperature of the product 122 being discharged from the space 118. The sensor 54 may be an infrared (IR) probe which is in communication with the controller 140 to provide signals of the product 122 temperature upon discharge from the freezer 110. Depending upon the temperature of the product 122 at discharge and as communicated to the controller 140, said controller will signal the modulating control valve 136 to adjust the amount of cryogen necessary to be introduced into the space 118 to be sprayed on the product 122. The flow meter 52 signals the controller 140 if such flow conforms to that being requested by the controller 140.

Therefore, introduction of the product 122 proximate the imaging system 50 coupled with the temperature of the product 122 sensed by the IR probe 126 can help to determine initially the amount of cryogen to be introduced into the space 118 by the nozzles 134 to contact the product 122 for sufficient chilling or freezing of the product. Accordingly, regardless of whether the product 122 is to be introduced to the freezer continuously or in batches, signals generated from the imaging system 50, IR probe 126, the flow meter 52 and the sensor 54 to the controller 140 are provided for adjusting the modulating control valve 136 to provide the requested amount of cryogen to be injected into the space 118 by the nozzles 134 on to the product 122.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A freezer for reducing the temperature of a product, comprising:
a housing comprising a chamber therein and an inlet and an outlet for said chamber;
a cryogen delivery assembly in communication with the chamber for delivering cryogen to the chamber;
a cryogen flow assembly in communication with the cryogen delivery assembly;
a conveyor for moving the product from the inlet through the chamber for exposure to the cryogen and for discharge at the outlet;
a product measurement assembly disposed proximate the conveyor at the inlet for measuring an amount of the product being introduced to the chamber at the inlet;
a first heat sensor disposed proximate the inlet for sensing a heat signature of the product; and
a controller in communication with and for receiving signals from the cryogen delivery assembly, the cryogen flow assembly, the conveyor, the product measurement assembly and the first heat sensor, the controller responsive to the signals for controlling the cryogen flow assembly to provide an amount of the cryogen to the cryogen delivery assembly for application to the product in an amount sufficient to reduce the temperature of the product.

2. The freezer of claim 1, further comprising a second heat sensor disposed proximate the conveyor at the outlet of the housing, the second heat sensor measuring the heat signature of the product at the outlet and being in communication with the controller.

3. The freezer of claim 1, wherein the cryogen is selected from the group consisting of carbon dioxide and nitrogen.

4. The freezer of claim 3, wherein the carbon dioxide and the nitrogen are in a liquid phase.

5. The freezer of claim 3, wherein the carbon dioxide and nitrogen are in a gaseous phase.

6. The freezer of claim 1, wherein the cryogen delivery assembly comprises at least one injection nozzle disposed in the chamber, and a delivery pipe interconnecting the at least one injection nozzle to a source of cryogen external to the housing.

7. The freezer of claim 6, wherein the cryogen flow assembly comprises a pressure transducer interposed in the delivery pipe upstream of the at least one injection nozzle, and a modulating control valve interposed in the delivery pipe upstream of the pressure transducer.

8. The freezer of claim 6, wherein the cryogen flow assembly comprises a modulating control valve interposed in the delivery pipe upstream of the at least one injection nozzle, and a flow meter interposed in the delivery pipe upstream of the modulating control valve.

9. The freezer of claim 1, wherein the product measurement assembly comprises a weight scale for measuring the weight of the product before the inlet.

10. The freezer of claim 1, wherein the product measurement assembly comprises an imaging system for measuring at least one of dimensions of the product, and an amount of a surface area of the belt covered by the product before the inlet.

11. The freezer of claim 2, wherein the first and second heat sensors are infrared (IR) sensors.

12. The freezer of claim 1, wherein the product is a food product.

13. A method for chilling a product, comprising:
measuring an amount and a temperature of a product to be chilled;
exposing the product to a chilling substance;
sensing the chilled product for sufficient chilling; and
adjusting an amount of the chilling substance to which the product is exposed based upon the amount and the temperature of the sensed chilled product to provide for the sufficient chilling of the product.

14. The method of claim 13, wherein the chilling substance is a cryogen selected from the group consisting of carbon dioxide and nitrogen.

15. The method of claim 13, wherein the product is a food product.
